(19) United States
(12) Patent Application Publication
(10) Pub. No.: US 2010/0042610 A1
(43) Pub. Date: Feb. 18, 2010

(54) RANK DOCUMENTS BASED ON POPULARITY OF KEY METADATA

(75) Inventors: Samir Lakhani, Seattle, WA (US); Xuemin Liu, Redmond, WA (US); Sandy Wong, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 12/192,819

(22) Filed: Aug. 15, 2008

(51) Int. Cl. G06F 7/06; G06F 17/30

(52) U.S. Cl. 707/5; 707/E17.014

(57) ABSTRACT

Ranking of documents by metadata popularity provides relevant search results in response to user search queries received by a search engine. Metadata popularity is determined by comparing metadata from a document with popularity data from one or more sources. In some embodiments, metadata popularity is determined based on a frequency with which extracted metadata appears in query logs. Search results are ordered based on metadata popularity and returned in response to the user search queries.

### BACKGROUND

The order in which search results from a search engine are presented to users is critical to user-perceived relevance of the search results. More relevant search results should appear at the top of the result list, while less relevant documents should appear lower in the result list. This reflects users' expectations that the results at the top of the result list are the most relevant to their search, such that the users do not need to sift through the search result list to find the desired information or document.

In an attempt to meet user expectations, search engines employ a variety of techniques for determining relevance and ordering search results. For instance, some search engines order search results using “click frequency,” which is indicative of the frequency with which users have historically “clicked” or selected a particular document from a search results set. However, this method of ranking can prove problematic when documents have an increased “click frequency” only because the documents were placed higher in result lists than other results and thus more likely to be clicked (i.e., a “self-fulfilled prophecy”). Ranking a document by its frequency of retrieval does not always reflect whether the actual document was a relevant result for the respective search.

Some search engines order search results in ways that reflect content-driven analysis of the documents associated with the search results, such as the prevalence of inter-linking between documents. However, such link-frequency calculations require document inter-linking, which doesn't naturally exist in many domains, such as amongst classified listings or products for sale. Accordingly, other documents will not include links to documents in those domains, and the documents' rank may therefore be disproportionately low.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to ordering search results for search queries based on popularity of metadata from documents. Generally, key metadata is identified from a document and the popularity of the metadata is determined. Metadata popularity may be identified using a variety of sources, but in some embodiment, the metadata popularity for a document is determined by comparing extracted metadata from the document to query logs to identify the frequency with which the extracted metadata appears in the query logs. In such embodiments, the frequency of metadata in query logs is used as an indicator of the popularity of that metadata to users. In some embodiments, metadata popularity for documents is used to order search results for user search queries. Accordingly, documents containing popular metadata will be ranked higher than documents having less popular metadata.

### BRIEF DESCRIPTION OF THE SEVERAL VIEWS OF THE DRAWING

The present invention is described in detail below with reference to the attached drawing figures, wherein:

FIG. 1 is a block diagram of an exemplary computing environment suitable for use in implementing the present invention;

FIG. 2 is block diagram providing an overview of indexing metadata popularity values for documents and using the metadata popularity for ranking search results in accordance with an embodiment of the present invention;

FIG. 3 is a flow diagram showing a method for indexing documents with metadata popularity values in accordance with an embodiment of the present invention;

FIG. 4 is a flow diagram showing a method of providing search results ranked based at least in part on metadata popularity in accordance with an embodiment of the present invention;

FIG. 5 is an illustrative screen display showing a search input box for a search engine in accordance with an embodiment of the present invention; and

FIG. 6 is an illustrative screen display showing a search results user interface including search results ranked based on metadata popularity in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to ranking documents in search results based on the popularity of metadata from the documents. In some embodiments, metadata popularity information determined for documents is indexed by a search engine with information regarding the documents. When the search engine receives user search queries, the search engine may employ the metadata popularity information to order search results to provide in response to the user search queries.

Metadata popularity may be determined from a variety of sources of popularity data in accordance with various embodiments of the present invention. In some embodiments, metadata popularity is determined by the frequency with which the document metadata appears in user search queries contained in query logs. If the metadata from a given document appears frequently in user search queries, the metadata may be determined to be popular such that the document is more likely to be relevant to a user. Although many embodiments will be discussed herein using query logs as the source of popularity data, other sources may be employed in other embodiments. For instance, if the metadata relates to companies, company popularity may be based on Fortune 500 rankings. As another example, if the metadata relates to products, product popularity could be based on sales data.

In accordance with some embodiments of the present invention, source documents to be indexed by a search engine and/or already indexed by a search engine are identified. A document classification is identified for each document, indicating that the document belongs to a given document domain. The terms “document classification” and “document domain” are used interchangeably herein to refer to a category to which a document may pertain based on the content of the document. For instance, document classifications or document domains may include employment, automobiles, classifieds, and products, to name a few. In an embodiment, the search engine may maintain a list or hierarchy of document classifications and may determine that a document corresponds with one of those document classifications.

A relevant metadata type is predetermined for each document classification. The specific metadata type determined to be relevant for a particular document classification is one that is likely to be an important feature for ranking documents belonging to that document classification. For example, amongst job listings, the popularity of an employer is likely to be a useful feature for ranking. Amongst automobile listings, the popularity of automobiles' make/model is likely to be a useful feature for ranking.

Based on the document classification for a given document and the corresponding relevant metadata type for that document classification, metadata of the relevant metadata type is extracted from the document. For instance, if a document is an automobile listing for a “Honda Accord,” the document may be identified as falling within the automobile classification, for which make/model is the relevant metadata type. As such, “Honda Accord” would be identified as the relevant metadata for the document.

Using metadata extracted from source documents, the popularity of the metadata is determined. In some embodiments, the popularity of the metadata is determined by analyzing query logs. In particular, the popularity of a given metadata is determined by identifying the frequency with which the metadata appears in user search queries in the query logs. Metadata popularity information is indexed for the source documents, and the indexed metadata popularity information is used to rank search results when the search engine receives search queries.

Accordingly, in one aspect, an embodiment of the invention is directed to computer-readable storage media embodying computer-useable instructions for performing a method of indexing documents with metadata popularity. The method includes identifying a source document and extracting metadata from the source document based on a document classification for the source document, wherein the document classification determines a type of metadata for extraction. The method also includes comparing the extracted metadata from the source document to query log data to identify a query log frequency, wherein the query log frequency is a frequency with which the extracted metadata appears in search queries in the query log. The method further includes assigning a metadata popularity value to the extracted metadata based on query log frequency and assigning the metadata popularity value to the source document. The method further includes storing the metadata popularity value in association with indexed information for the source document.

In another embodiment of the invention, an aspect is directed to a computer-implemented method for ordering search results based on metadata popularity. The method includes receiving a user search query. The method also includes generating search results based on the user search query, wherein each search result corresponds with a document. The method further includes ordering the search results based at least in part on metadata popularity values stored in association with indexed information for the documents, wherein the metadata popularity values for the documents are based on popularity of relevant metadata from the documents identified from popularity data from one or more sources, and wherein the relevant metadata from the documents is identified based on document classifications for the documents. The method still further includes communicating the ordered search results in response to the user search query.

A further embodiment of the present invention is directed to computer-readable storage media embodying computer-useable instructions for performing a method of providing search results ordered based at least in part on metadata popularity. The method includes identifying, a source document, identifying a document classification for the source document, and identifying a relevant metadata type based on the document classification for the source document. The method also includes extracting metadata of the relevant metadata type from the source document and determining a frequency with which the extracted metadata appears in query log data. The method further includes assigning a metadata popularity value to the source document based on the frequency with which the extracted metadata appears in the query log data and storing the metadata popularity value in an index containing information indexed for the source document. The method further includes receiving a user search query, identifying a query classification for the user search query, and querying the index to identify relevant documents for the user search query based on the query classification, wherein the relevant documents include the source document and other documents. The method also includes generating search results based on the relevant documents, wherein the search results are ordered based at least in part on the metadata popularity value for the source document and other metadata popularity values for at least a portion of the other documents. The method still further includes providing the search results in response to the user search query.

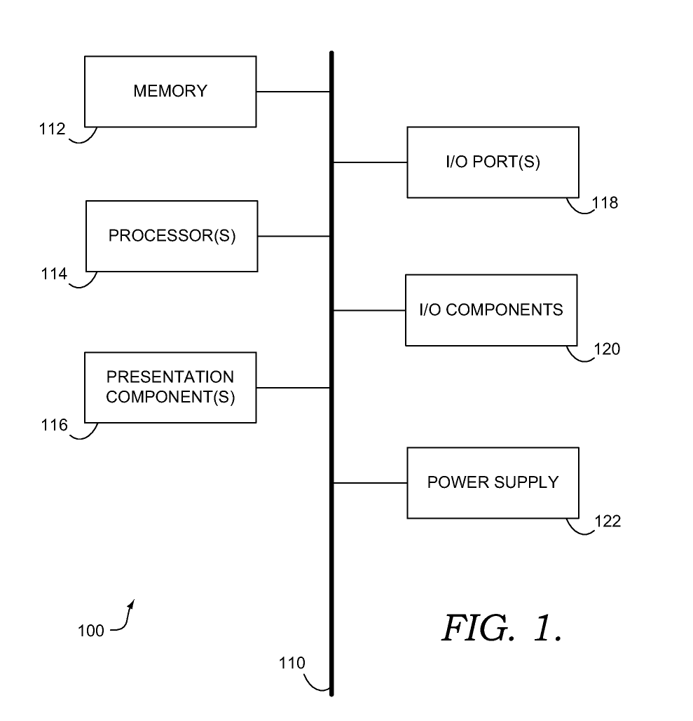

Having briefly described an overview of the present invention, an exemplary operating environment in which various aspects of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

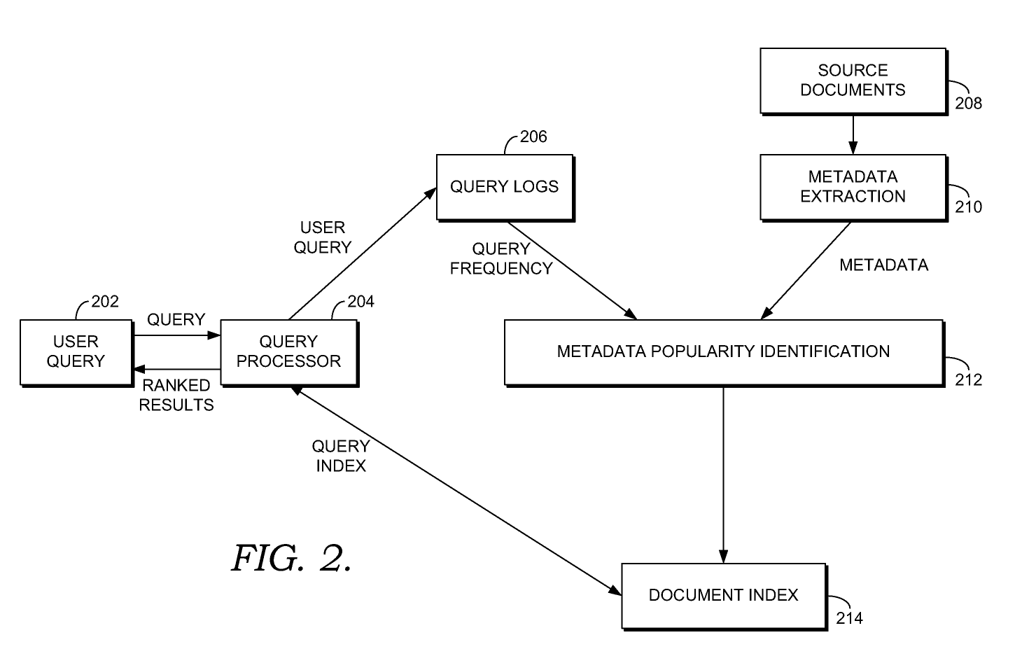

Referring now to FIG. 2, a block diagram is provided that illustrates an overview of a system for determining metadata popularity for documents and using the metadata popularity for ranking search results in accordance with an embodiment of the present invention. The system generally determines and indexes metadata popularity values for source documents 208 such that the metadata popularity values may be used to rank search results returned for a user query 202. The system shown in FIG. 2 illustrates an embodiment in which query logs are used as the source of popularity data for determine metadata popularity. As indicated above, other sources of popularity data may be used to determine metadata popularity in accordance with other embodiments of the present invention.

As shown FIG. 2, the system performs metadata extraction 210 on the source documents 208 to identify relevant metadata for each source document. In an embodiment, the system extracts metadata from each source document by classifying the source document and extracting metadata of a metadata type that has been identified as being particularly relevant for the document classification. For instance, the system may maintain a list or hierarchy of document classifications (e.g., employment, automobiles, classifieds, products, etc.). For each document classification, a metadata type is identified as being a feature that is particularly relevant to that document classification such that it is likely to be a useful feature for ranking documents within that document classification. By way of example, employer may be identified as a relevant metadata type for employment listings and an automobile's make and model may be identified as a relevant metadata type for automobile listings.

The system performs metadata popularity identification 212 to determine the popularity of metadata extracted from the documents. In particular, the system analyzes query logs 206 to identify the frequency with which the extracted metadata appears in user queries contained in the query logs 206. The popularity of the metadata is thus determined based on the frequency of the metadata within the user search queries. If a metadata has a high frequency of appearance in the user search queries, the metadata is determined to be popular. Alternatively, if a metadata has a low frequency of appearance in the user search queries, the metadata is determined not to be popular.

In some embodiments, all or a substantial portion of the search queries from the query logs 206 are analyzed to determine the popularity of metadata. In other embodiments, the user search queries are classified and the system uses only those search queries that correspond with a classification matching the document classification for a document from which the metadata was extracted. For instance, if popularity is being determined for metadata from a source document classified within the employment domain, the system may identify search queries intended for the employment domain and use only those search queries to identify popularity for the metadata.

A metadata popularity value is determined for each item of metadata based on the user query frequency information from the query logs. The metadata popularity values of metadata from each source document is indexed with information for each source document in the document index 214.

By indexing the metadata popularity values, the search engine may access the indexed metadata popularity to order search results for user queries. In particular, when a user query 202 is received, a query processor 204 processes the user query. As shown in FIG. 2, processing the user query 202 may include both logging information about the user query 202 in the query logs 206 and returning search results for the user query 202. To obtain search results, the user query 202 may be classified to identify an intent of the user query 202 and determine a document domain from which to select documents to return as search results. For instance, a search query that includes the terms “Seattle jobs” may be classified as an employment search as it is likely the user intends the search query to return search results related to employment listings. Based on the user classification, documents from the document index 214 may be identified. Indexed metadata popularity values are identified from the document index 214 and used to order the search results, which are returned in response to the user query 202. It should be understood that the metadata popularity may be used alone or in conjunction with other ranking features to order search results in various embodiments of the present invention.

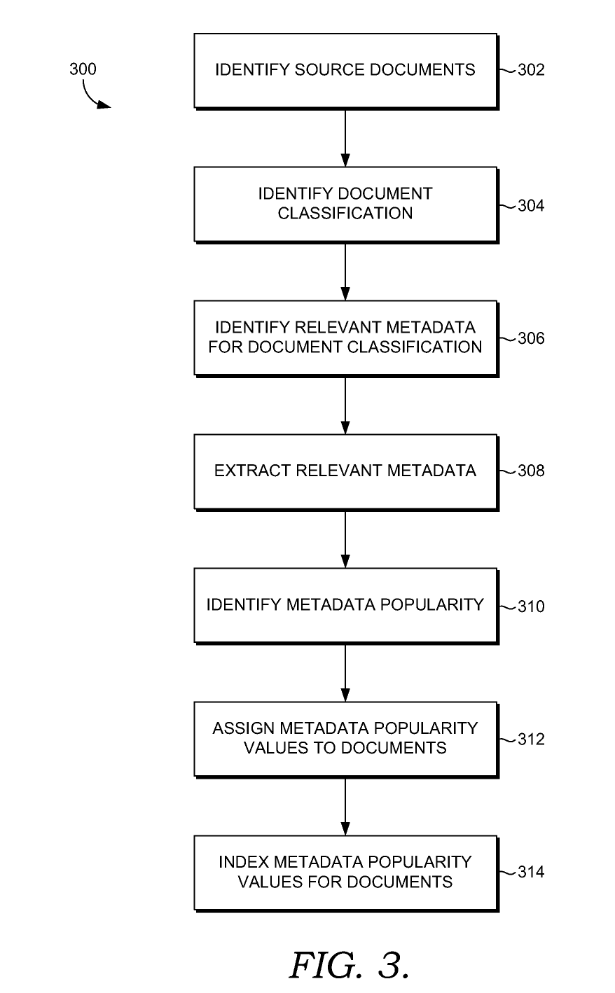

Turning now to FIG. 3, a flow diagram is provided that illustrates a method 300 for determining metadata popularity for documents and indexing the metadata popularity in accordance with an embodiment of the present invention. As shown at block 302, source documents are identified. Each source document may generally be, for instance, any type of document for which information may be indexed by the search engine, such that the search engine may provide a search result corresponding with the source document in response to user search queries.

A document classification is identified for each source document, as shown at block 304. Those skilled in the art will recognize that documents may be classified in any of a variety of different manners within the scope of embodiments of the present invention. In some embodiments, a variety of different document classifications may be predetermined for use by the system to classify source documents. By way of example only and not limitation, the document classifications may include employment, automobiles, classifieds, and products.

As shown at block 306, a relevant metadata type is identified for each source document based on the identified document classification for each source document. As noted previously, a relevant metadata type is established for each document classification. In embodiments of the present invention, the relevant metadata type for a given document classification may be identified by human judgment. A metadata type is selected for a given document classification if the metadata type is one that is likely to be useful for ranking documents within that document classification. For instance, employer may be identified as the relevant metadata type for employment listings, and automobile make/model may be identified as the relevant metadata type for automobile listings.

Metadata corresponding with the identified metadata type is extracted from each source document, as shown at block 308. For instance, suppose that a source document is a job listing for Microsoft. The classification of the source document would be identified as employment, the relevant metadata type would be identified as employer, and the metadata extracted from the source document would be identified as “Microsoft” (i.e., the specific employer associated with the document). As another example, suppose that a source document is an automobile listing for a Honda Accord. The source document would be classified in the automobile domain for which make/model is the relevant metadata type, and the metadata extracted from the source document would be “Honda Accord” (i.e., the specific make/model associated with the document).

Popularity for the extracted metadata from the source documents is identified to generate a metadata popularity value for each extracted metadata, as shown at block 310. As noted above, various sources of popularity data may be used to determine metadata popularity. In some embodiments, information from query logs is used to determine metadata popularity. Generally, in such embodiments, metadata popularity is based on the frequency with which the metadata appears within user search queries from the query logs. For instance, if “Honda Accord” appears in more queries than “Toyota Camry” in the query logs, the “Honda Accord” metadata will receive a higher metadata popularity value than “Toyota Camry” metadata. A variety of different techniques may be employed to identify metadata popularity value using query logs in accordance with embodiments of the present invention. For instance, a text-matching or CRF-based classifier may be employed for extracting metadata from the search queries to identify a frequency with which metadata appears in the search queries. The frequency of metadata amongst the search queries in the query logs is used to generated a metadata popularity value. Accordingly, the metadata popularity value for a given metadata may be a value that represents the frequency of that metadata in the search queries or may be ranking based on comparison with other metadata in the same domain.

In some embodiments of the present invention, metadata popularity may be determined by analyzing the frequency of metadata in all or a substantial portion of search queries in the query logs. In other embodiments of the present invention, query classification may be employed to identify classifications for user search queries. In such embodiments, only search queries having a classification that matches the document classification from which metadata was extracted is employed for determining the metadata popularity. For instance, if “Microsoft” is identified as metadata from a source document classified in the employment domain, only search queries classified as employment queries are used to identify the popularity of the metadata. As such, query classification is used to identify a subset of user queries from the query logs to employ for determining metadata popularity for metadata from a given document domain. This recognizes that although metadata may appear frequently in the user queries, the queries may not be relevant to the domain for the document from which the metadata was extracted. For instance, suppose that “Microsoft” is identified as the relevant metadata for a source document in the employment domain. There may be a large number of search queries containing the metadata “Microsoft.” However, most the these search queries may be directed to finding information on Microsoft software products and are not directed to searching for jobs with Microsoft. As such, if all search queries were employed, the metadata “Microsoft” would be given a high metadata popularity value based on the high frequency of the metadata in the search queries despite the fact that the metadata is not a popular search in the employment domain. Accordingly, by identifying search queries that correspond to the employment domain and using only those queries to identify popularity of the metadata, a metadata popularity value that better reflects the popularity of the metadata within the relevant domain is identified.

In further embodiments, the popularity of a metadata value is not necessarily absolute across documents. It is often the case that the value is conditioned on a secondary value on the document. By way of example, the popularity of Microsoft as an employer is different depending on the category of the job. Microsoft may be popular for Engineering jobs, but may not be so popular for Human Resources jobs. For instance, if the metadata popularity score is a numerical value, the employer popularity for Microsoft if the job category of a document is engineering is 100, whereas employer popularity for Microsoft if the job category of document is human resources is 20.

As a result, an optional processing step is included in some embodiments to calculate the popularity of the key metadata attribute based on the occurrence of secondary metadata values. This is referred to herein as the conditional metadata popularity. This step can include any number of secondary values to consider when conditioning the key metadata popularity. In embodiments, the secondary value is determined manually based on analysis of the document domain. By way of example, the metadata popularity may be determined for a document having key metadata=X, given the occurrence of secondary metadata=Y, to reflect the probability that a user is interested in X given the occurrence of secondary value Y. This is represented as P(X|Y). Based on Bayes theorem, P(X|Y) is proportional to P(X)*P(Y|X)=Normalized Frequency of X in Queries*Percentage of documents with X that have Y

Referring again to FIG. 3, a metadata popularity value is assigned to each source document based on the metadata extracted from the source document and the metadata popularity value determined for the extracted metadata, as shown at block 312. For instance, if the extracted metadata for a source document in the employment domain is “Microsoft” as the employer, the source document is assigned the metadata popularity value determined for the metadata “Microsoft. As another example, if the extracted metadata for a source document in the automobile domain is “Honda Accord” as the make/model, the source document is assigned the metadata popularity value determined for the metadata “Honda Accord.” The metadata popularity value assigned to each source documents is indexed in associated with information from each source document, as shown at block 314.

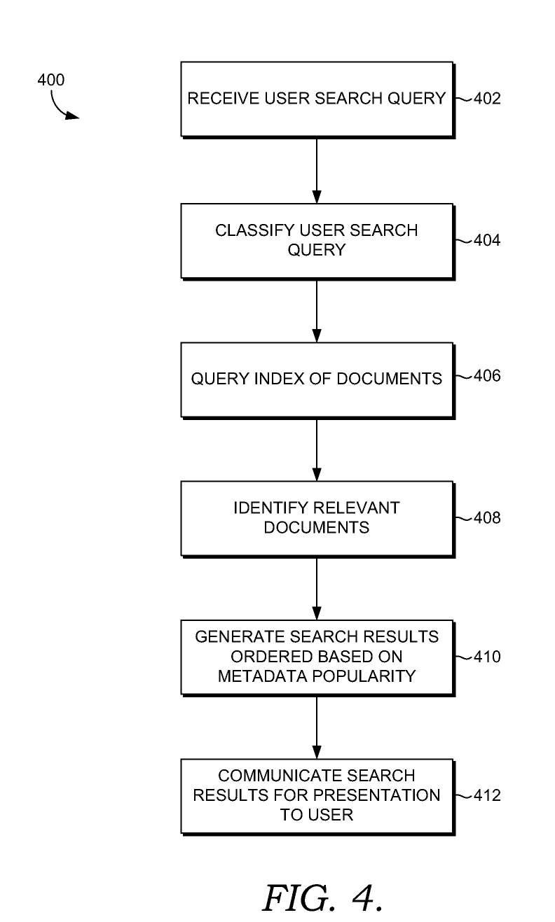

After documents have been indexed with metadata popularity values, search results may be provided in response to user search queries in which the search results are ranked based on associated metadata popularity values. Turning to FIG. 4, a flow diagram is provided illustrating a method 400 for providing search results ranked by metadata popularity in response to a user search query in accordance with an embodiment of the present invention. Initially, as shown at block 402, a user search query is received. The user search query generally includes one or more search terms.

The user search query is classified at block 404. In particular, a classification for the user search query is determined that attempts to identify the intent of the user search query. In other words, the query classification attempts to identify the types of documents the user wishes to have returned as search results. By classifying the user search query, the system may determine a domain of documents that are relevant to the user search query. For instance, a user search query may be classified as an employment query such that documents within the employment domain may be identified as relevant search results for the query. One skilled in the art will recognize that query classification may be performed in a variety of different manners within the scope of embodiments of the present invention. For instance, in some embodiments, the user search query may be classified by analyzing the one or more search terms of the search query. In some embodiments, a user entering a search query may specifically identify a domain to search. Any and all such variations are contemplated to be within the scope of embodiments of the present invention.

As shown at block 406, an index is queried for documents within the domain corresponding with the query classification. Continuing the example above, if the user search query is classified as an employment search, the index is queried for documents within the employment domain (e.g., documents identified as having an employment document classification). By querying the index, documents within the relevant domain and having relevance to the user search query are identified, as shown at block 408.

In accordance with embodiments of the present invention, the document index contains metadata popularity values associated with documents. The metadata popularity values may have been determined using a method such as that described above with reference to FIG. 3. For instance, in some embodiments, the metadata popularity value associated with a given document represents the popularity of relevant metadata of the document as determined by identifying the frequency of the relevant metadata in search queries contained in query logs.

Search results are generated based on the index query, as shown at block 410. Each search result corresponds with an indexed document. The search results are ordered based on the metadata popularity values associated with the corresponding documents as indicated in the document index. Accordingly, the search results are ranked based on document metadata popularity.

The search results are communicated for presentation to the user at block 412. For instance, a search results user interface may be generated that includes the search results ordered based on their associated metadata popularity values. The search results user interface is then communicated to the user's computer and presented to the user, for instance, using a browser on the user's computer.

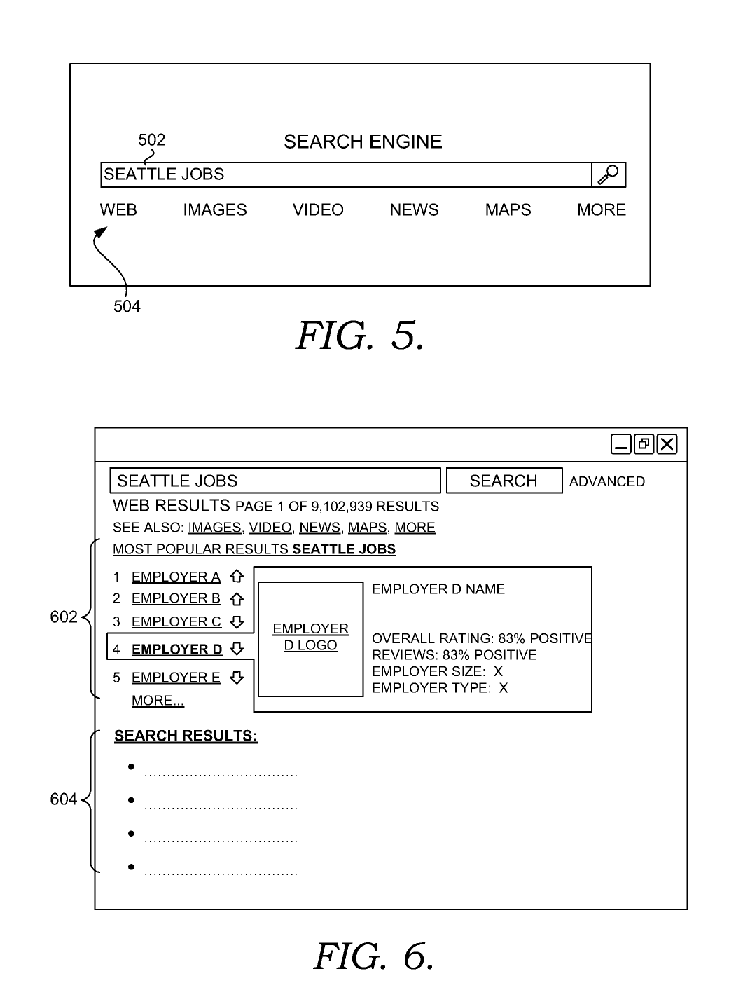

Referring now to FIG. 5 and FIG. 6, exemplary screen displays are provided illustrating search results being returned in response to a user search query in which a portion of the search results are ordered based on metadata popularity in accordance with an embodiment of the present invention. It will be understood and appreciated by those of ordinary skill in the art that the screen displays of FIG. 5 through FIG. 6 are provided by way of example only and are not intended to limit the scope of the present invention in any way.

Referring initially to FIG. 5, an exemplary screen display of a search user interface is shown. The search interface includes a search input box 502 that may be provided, for instance, via a search engine web page. The search input box 502 allows a user to enter a search query for search purposes. As known in the art and shown in FIG. 5, a search engine may provide a variety of searching capabilities, including a broad web search and a variety of vertical searches. Accordingly, a number of search selections 504 are provided in conjunction with the search input box 502. By inputting a search query in the search input box 502 and selecting one of the search selections 504, a user may cause the search engine to perform the selected type of search using the inputted search query. In some embodiments, the search selections 504 may include options allowing the user to identify a specific domain (e.g., “employment” or “automobiles) to search.

In the present example, the user has entered the terms “Seattle jobs” as the search query in the search input box 502. In response to the user search query, the search engine performs a search and prepares a search results user interface containing search results, as shown in the screen display of FIG. 6. In accordance with embodiments of the present invention, to provide the search results user interface, the search engine may first classify the user search query within the employment domain and searches for documents within that domain. Additionally, the search engine identifies metadata popularity values associated with documents within the employment domain and uses those metadata popularity values to rank the search results corresponding with those documents. As shown in FIG. 6, a number of search results are included in a “Most Popular Results” section 602 of the search results user interface. These include the search results corresponding with documents in the relevant domain (i.e., employment) and are ordered based on associated metadata popularity values. In the present example, the search results user interface also includes other search results in a separate section 604 of the search results user interface. These may include search results from other domains and/or search results that do not have metadata popularity values.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer-readable storage media embodying computer-useable instructions for performing a method of indexing one or more documents with metadata popularity, the method comprising:
identifying a source document;
extracting metadata from the source document based on a document classification for the source document, wherein the document classification determines a type of metadata for extraction;
comparing the extracted metadata from the source document to query log data to identify a query log frequency, wherein the query log frequency is a frequency with which the extracted metadata appears in search queries in the query log;
assigning a metadata popularity value to the extracted metadata based on query log frequency;
assigning the metadata popularity value to the source document; and
storing the metadata popularity value in association with indexed information for the source document.

2. The computer-readable media storage of claim 1, wherein extracting metadata from the source document comprises:
classifying the source document into one of a plurality of predefined document classifications; and
identifying the type of metadata for metadata extraction from the source document based on the document classification.

3. The computer-readable storage media of claim 2, wherein each of the plurality of predefined document classifications is associated with a predefined type of metadata for metadata extraction.

4. The computer-readable storage media of claim 3, wherein the predefined type of metadata for metadata extraction is identified and associated with each of the plurality of predefined document classifications based on human judgment.

5. The computer-readable storage media of claim 1, wherein the query log frequency comprises a frequency with which the extracted metadata appears in all of the search queries in the query log data.

6. The computer-readable storage media of claim 1, wherein the query log frequency comprises a frequency with which the extracted metadata appears in search queries in the query log data that have a classification matching the document classification for the source document.

7. The computer-readable storage media of claim 1, wherein the method further comprises:
receiving a search query; and
providing search results based on the search query wherein the search results correspond with the source document and a plurality of other source documents, and wherein the search results are ordered based at least in part on the metadata popularity value associated with the source document and other metadata popularity values associated with the other source documents.

8. A computer-implemented method for ordering search results based on metadata popularity, the method comprising:
receiving a user search query;
generating search results based on the user search query, wherein each search result corresponds with a document;
ordering the search results based at least in part on metadata popularity values stored in association with indexed information for the documents, wherein the metadata popularity values for the documents are based on popularity of relevant metadata from the documents identified from popularity data from one or more sources, and wherein the relevant metadata from the documents is identified based on document classifications for the documents; and
communicating the ordered search results in response to the user search query.

9. The method of claim 8, wherein generating search results based on the user search query comprises determining a query classification for the user search query.

10. The method of claim 9, wherein generating search results further comprises identifying documents that are relevant to the query classification.

11. The method of claim 9, wherein generating search results further comprises identifying documents from a document domain corresponding with the query classification.

12. The method of claim 8, wherein the metadata popularity values comprise ranks, and wherein ordering the search results comprises ordering the search results numerically by rank.

13. The method of claim 8, wherein the metadata popularity values for the documents are based on a frequency with which relevant metadata from the documents appears in all search queries in one or more query logs.

14. The method of claim 8, wherein the metadata popularity values for the documents are based on a frequency with which relevant metadata from the documents appears in a portion of search queries in one or more query logs, the portion of the search queries being selected based on query classification.

15. One or more computer-readable storage media embodying computer-useable instructions for performing a method of providing search results ordered based at least in part on metadata popularity, the method comprising:
identifying a source document;
identifying a document classification for the source document;
identifying a relevant metadata type based on the document classification for the source document;
extracting metadata of the relevant metadata type from the source document;
determining a frequency with which the extracted metadata appears in query log data;
assigning a metadata popularity value to the source document based on the frequency with which the extracted metadata appears in the query log data;
storing the metadata popularity value in an index containing information indexed for the source document;
receiving a user search query;
identifying a query classification for the user search query;
querying the index to identify relevant documents for the user search query based on the query classification, wherein the relevant documents include the source document and other documents;
generating search results based on the relevant documents, wherein the search results are ordered based at least in part on the metadata popularity value for the source document and other metadata popularity values for at least a portion of the other documents; and
providing the search results in response to the user search query.

16. The one or more-computer-readable storage media of claim 15, wherein the relevant metadata type for the document classification is predefined by human judgment.

17. The one or more computer-readable storage media of claim 15, wherein determining a frequency with which the extracted metadata appears in query log data comprises determining a frequency with which the extracted metadata appears in all search queries in the query log data.

18. The one or more computer-readable storage media of claim 15, wherein determining a frequency with which the extracted metadata appears in query log data comprises determining a frequency with which the extracted metadata appears in search queries in the query log data having a query classification corresponding with the document classification of the source document.

19. The one or more computer-readable storage media of claim 15, wherein the metadata popularity value comprises a rank.

20. The one or more computer-readable storage media of claim 19, wherein the search results are ordered in numerical order based on rank.
